(19) United States
(12) Patent Application Publication
(10) Pub. No.: US 2012/0072752 A1
(43) Pub. Date: Mar. 22, 2012

(54) METHOD AND APPARATUS FOR PROVIDING POWER MANAGEMENT ENHANCEMENTS

(75) Inventors: Sean Kennedy, San Diego, CA (US); Edward Winter, San Diego, CA (US); Gary Lyons, San Diego, CA (US); Paul Hwang, Solana Beach, CA (US); Rommel Garay, San Marcos, CA (US); Christopher Ohren, San Diego, CA (US); Fredrik Carpio, San Diego, CA (US); Michael Chang, San Diego, CA (US); Drew Lawton, San Marcos, CA (US)

(73) Assignee: SONY CORPORATION, Tokyo (JP)

(21) Appl. No.: 12/888,025

(22) Filed: Sep. 22, 2010

(51) Int. Cl. G06F 1/32; G06F 1/26; G06F 1/00

(52) U.S. Cl. 713/323; 713/324; 713/300; 713/340; 713/320

(57) ABSTRACT

A method and apparatus for providing power management enhancements. In an embodiment, the method comprises receiving an indication that the computing device is in a non-user-interactable state and powering down non-essential device components such that the computing device is configured to enter a low power state. In another embodiment, the method comprises selecting a duration for a battery life of the computing device and selecting a power profile for the computing device to ensure that the computing device operates for at least as long as the selected duration. In an embodiment, the apparatus comprises a computing device comprising means for providing battery power and means for altering a power profile of the computing device.

### BACKGROUND

1. Field of the Invention

Embodiments of the present invention generally relate to computer power management and, more particularly, to a method and apparatus for providing power management enhancements.

2. Description of the Related Art

In the information age, society has become more and more dependent upon computers. Users increasingly rely on mobile computing devices such as laptops, personal digital assistants, and cellular phones. These devices necessarily run on battery power as a result of their mobile nature. Since it is not always practical to plug in one's device to recharge, the battery life of a device is an important component of its operational capability. The most powerful laptop is of limited use to the user if the battery depletes after only a few minutes. The fastest, most feature-rich smart phone is worthless if it cannot sustain a call for more than a short time. As such, developers constantly seek ways to improve device battery life.

Some devices have low power settings that allow the user to sacrifice performance and/or features at the cost of increased battery life. However, the user must constantly monitor what his device power settings are, and remember to switch between usage profiles depending upon the circumstances. Therefore, there is a need in the art for a method and apparatus for providing power management enhancements.

### SUMMARY OF THE INVENTION

Embodiments of the present disclosure generally relate to a method and apparatus for providing power management enhancements. In an embodiment, the method comprises receiving an indication that the computing device is in a non-user-interactable state and powering down non-essential device components such that the computing device is configured to enter a low power state.

In another embodiment, the method comprises selecting a duration for a battery life of the computing device and selecting a power profile for the computing device to ensure that the computing device operates for at least as long as the selected duration.

In yet another embodiment, the apparatus comprises a computing device comprising means for providing battery power and means for altering a power profile of the computing device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a computing device in accordance with embodiments of the present invention;

FIG. 2 is a flow diagram depicting an embodiment of a method for conserving battery power in accordance with embodiments of the present invention;

FIG. 3 is a flow diagram depicting an embodiment of a method for conserving battery power in accordance with embodiments of the present invention; and

FIGS. 4A and 4B are flow diagrams depicting an embodiment of a method for conserving battery power in accordance with embodiments of the present invention.

### DETAILED DESCRIPTION

As explained further below, various embodiments of the invention disclose a method and apparatus for providing power management enhancements for a mobile computing device. For the purposes of this application, the term “power profile” is used to designate a specific configuration of a computing device, reflecting whether various components of the computing device are receiving electrical power, executing services, auxiliary hardware power levels, display brightness, applications in use, and the like. For example, in a specific power profile, the central processing unit (CPU), memory, hard disk, and display may be configured to only receive the minimum amount of power necessary to continue execution, in order to conserve battery life. In another specific power profile, the various system components may be fully powered to maximize performance. One of ordinary skill in the art would recognize that a variety of power profiles could be used for specific system configuration for various tasks reflecting a balance between performance and battery life.

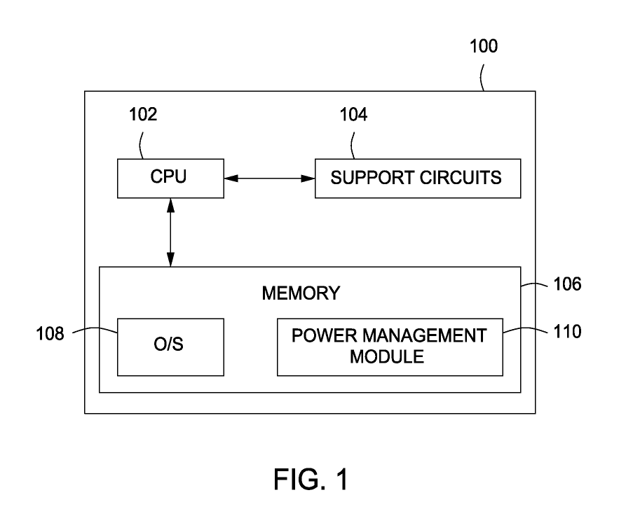

FIG. 1 illustrates a computer 100 implementing an embodiment of the present invention. Said computer 100 operates to execute various programs and applications as desired by a user. The computer 100 may be any computing device capable of being powered by a battery as known in the art, such as a laptop computer, a personal digital assistant (PDA), a smart phone, an mp3 player, and the like.

The computer 100 may include a central processing unit (CPU) 102, a memory 106, and various support circuits 104. The CPU 102 may include one or more microprocessors or the like as known in the art. The support circuits 104 include conventional cache, power supplies, clock circuits, data registers, and the like used in conjunction with software executing on the CPU 102. The memory 106, or computer readable medium, may include one or more of the following random access memory, read only memory, magneto-resistive read/write memory, optical read/write memory, cache memory, magnetic read/write memory, and the like.

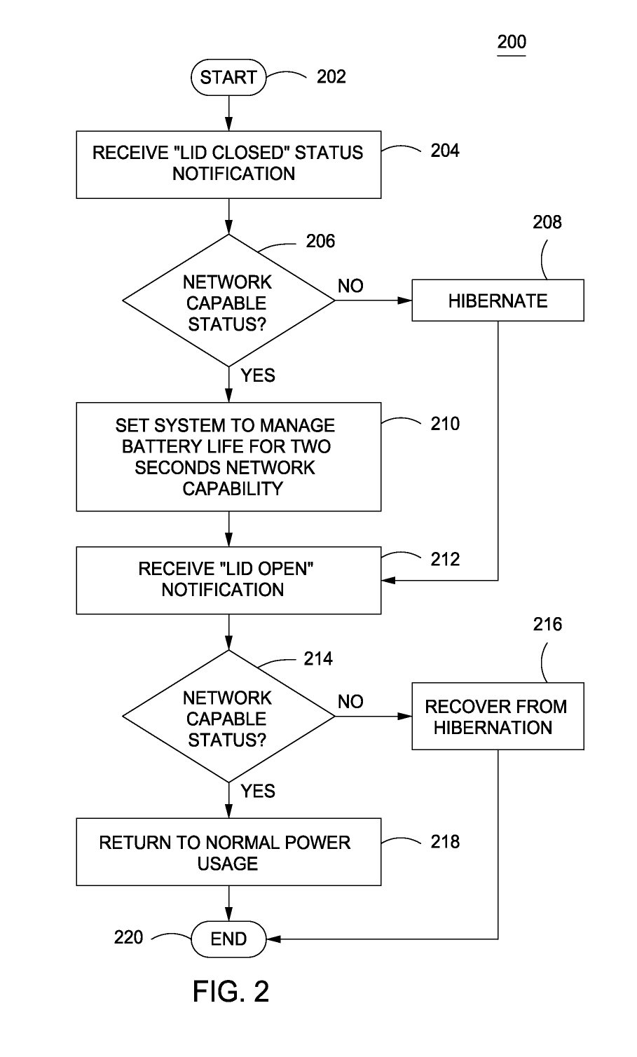

The memory 106 may store software that is executed to perform methods according to embodiments of the invention. For example, the software can implement at least a portion of the methods 200, 300, and 400 discussed with respect to FIGS. 2, 3, and 4. The software, when executed by the processor 102, transforms the general purpose computer into a specific purpose computer that controls methods described herein. Although embodiments of the process of the present invention are discussed as being implemented as a software routine, some of the method steps that are disclosed herein may be performed in hardware or a combination of hardware and software. As such, the invention may be implemented in software as executed upon a computer system, in hardware as an application specific integrated circuit or other type of hardware implementation, or a combination of software and hardware.

Additionally, the software may act as a “stand alone” program or may be embedded with one or more other routines or programs that provide one or more additional services. The software of the present invention is capable of being executed on computer operating systems including but not limited to MICROSOFT WINDOWS 98, MICROSOFT WINDOWS XP, APPLE OS X, LINUX, and/or other commercially and publicly available operating systems. Similarly, the software of the present invention is capable of being performed using CPU architectures including but not limited to APPLE POWERPC, AMD/INTEL x86, SUN SPARC, and INTEL ARM.

In some embodiments, the memory comprises an operating system 108 and a power management module 110. In operation, the CPU 102 executes the operating system 108 to control the general utilization and functionality of the computer 200. The CPU 102 executes the power management module 110 to perform power management operations in accordance with embodiments of the present invention. The power management module 110 monitors and controls various aspects of the computer 100 that relate to power supply and consumption. The power management module 110 may include the ability to choose between various power profiles to manage power consumption and system performance. The power profiles may include activating and/or deactivating various features of the computer to conserve power, such as dimming a display screen when a low power profile is selected. The power management module 110 operates to perform methods of managing power consumption as described with respect to FIGS. 2, 3, and 4.

FIG. 2 is a flow diagram depicting a method 200 for providing power management enhancements in accordance with embodiments of the present invention. The method begins at step 202 and proceeds to step 204. At step 204, the method receives a “lid closed” status message from a sensor. In this specific exemplary embodiment, the “lid closed” status indicates that a user has closed a lid/screen of a laptop executing the method. Such a status may be received by a sensor included in the latch mechanism of a laptop, a sensor located in the hinge between the screen and base, or any other indication that the laptop lid is closed. One of ordinary skill in the art would recognize that such a status could also correspond to any indication that the user does not currently wish to interact with the computing device, such as by powering off a display component, muting an audio device, stopping playback on a portable video player, and the like. After receiving the “lid closed” status, the method proceeds to step 206.

At step 206, the method 200 issues a query to determine if the system is set for “network capable.” The network capable status may be stored by the operating system as a configuration option, such as in a system registry or environment variable. The network capable status determines whether the system should enter a power profile such that the system can instantly or near instantly (within a few seconds) used to access a network upon opening the lid. If the system is not set to “network capable,” the method proceeds to step 208. If the system is set to “network capable,” the method proceeds to step 210.

At step 208, if the system is not set to network capable, the system enters hibernation as generally known in the art. For the purpose of this application, the term hibernation refers to saving all state data and volatile memory to a non-volatile storage and powering off the device, such that when the device receives instruction to power on again, the system loads from the stored state/volatile memory data saved in non-volatile storage. After initiating hibernation, the method 200 proceeds to step 212.

If the system is set to network capable, the method 200 proceeds to step 210 from step 206. At step 210, the power management module of the system configures the system to a state where the system will be able to access the network within 2 seconds of reopening the lid. This configuration may include continuing to power the components necessary to keep the operating system executing in a low power configuration such as the CPU, memory, fans, and network devices. This configuration also includes powering off non-essential components that would otherwise consume power, such as the display. The low power configuration may include continuing to power the components necessary to keep the operating system executing in a low power configuration such as the CPU, memory, fans, and network devices. The low power configuration also includes powering off non-essential components that would otherwise consume power, such as the Display, Hard Disc Drive (HDD), Optical Disc Drive (ODD), or any other device on the system which is not essential to meeting the 2 sec lid-open response time. After entering the low power configuration, the method proceeds to step 212.

At step 212, the system receives a “lid open” notification. As above, the lid open notification may result from a sensor placed in the lid latch, a sensor attached to a hinge between a laptop screen and base, or any other indication that a laptop lid was opened. As above, one of ordinary skill would recognize that such a notification could also correspond to other indications that the user intends to interact with the computing device, such as powering on a display, pressing play on an audio file, inserting a DVD in a portable DVD player, and the like. After receiving the “lid open” notification, the method 200 proceeds to step 214.

At step 214, the method 200 queries the network capable status of the system again. If the system is configured for the network capable status, the method 200 proceeds to step 218. If the system is not configured for the network capable status, the method 200 proceeds to step 216.

At step 216, if the system was not configured for network capable status, the system recovers from hibernation by loading from the system and volatile memory that was saved to non-volatile storage. The method 200 then ends at step 220.

If the system was configured for the network capable status, the method 200 proceeds to step 218 from step 214. At step 218, the method reactivates the components of the system that were powered down in response to the “lid closed” notification. After returning to a normal power configuration, the method 200 ends at step 220.

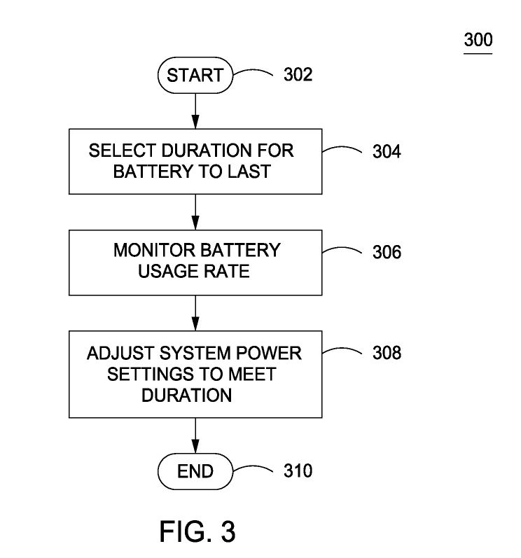

FIG. 3 is a flow diagram depicting a method 300 for providing power management enhancements in accordance with embodiments of the present invention. The method 300 begins at step 302. At step 304, a user sets a specific duration for the battery power of a computing device to last. For example, the user may select that the device should operate to last at least one hour. In some embodiments, the method may include determining a maximum battery length for the computing device, and allowing the user to select any time value that is less than the maximum length of time. The method then proceeds to step 306.

At step 306, the system monitors the rate of battery consumption to determine how long the system can last if it continues to operate at the current power profile. In some embodiments, the system may make a best estimate for a particular power profile after the user selects the duration, but before entering the power profile. In some embodiments, the system may use a calibration period to determine battery usage rates for different power profiles, prior to selecting a power profile to meet the particular selected duration. In some embodiments, the system may make a “best guess” about power consumption for particular power profiles, selecting the highest performance power profile that will last at least as long as the selected duration. After monitoring the battery life for a specific period (where the specific period may be a set time such as 5 minutes, or may be configurable), the method 300 proceeds to step 308.

At step 308, the method 300 adjusts the system power profile to last at least as long as the selected duration. Step 308 may require dropping to a lower performance power profile if monitoring indicates that the current power profile will not last the selected duration. If the method 300 determines that a higher power profile may enable the system to continue to reach the selected duration, the method 300 may enter the higher power profile. The method 300 ends at step 310 when the selected duration expires.

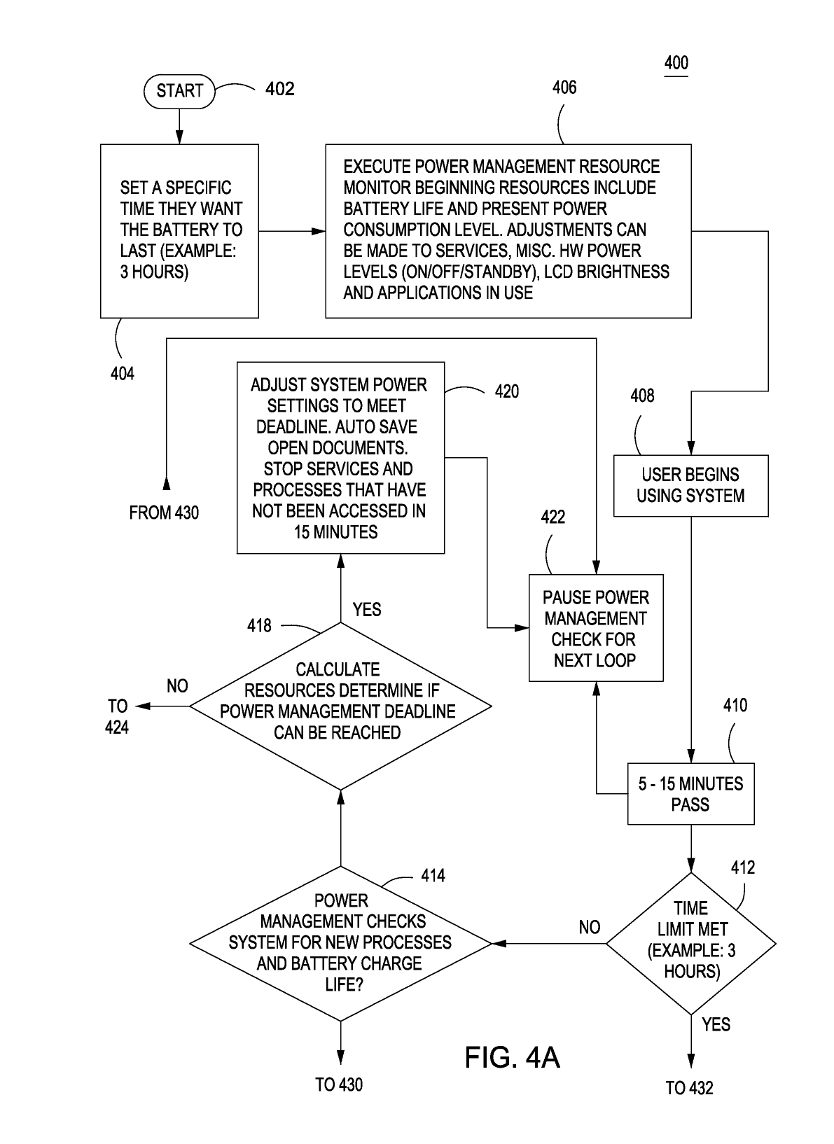

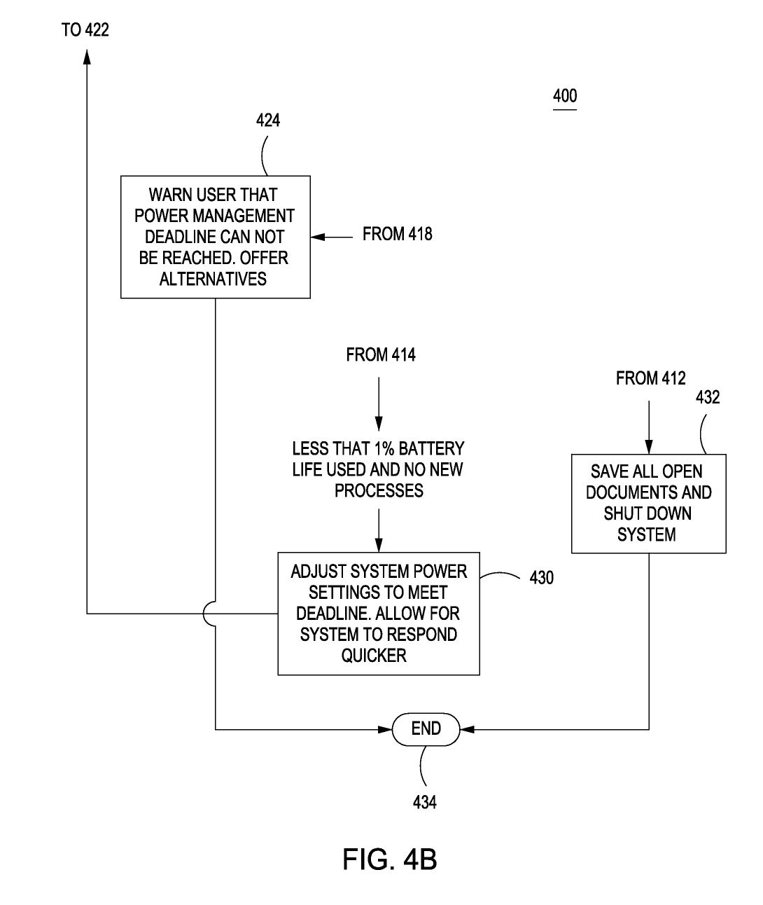

FIGS. 4A and 4B are flow diagrams depicting a method 400 for providing power management enhancements. The method 400 begins at step 402 and proceeds to step 404. At step 404, a specific duration for the system battery is selected. For example, a user may select a particular time frame. In some embodiments, as discussed with respect to FIG. 3, the user may be presented with the option to select any duration that is less than the maximum battery life at the lowest performance (and maximum battery life) power profile. Once a duration is selected, the method 400 proceeds to step 406.

At step 406, the method executes a power management resource monitor to determine the current battery life and current power consumption level. The power management monitor may make adjustments to the executing services, auxiliary hardware power levels, display brightness, applications in use, and the like. After making initial adjustments to the system power profile, the method 400 proceeds to step 408.

At step 408 the user begins using the system in the current power profile configuration. The method then proceeds to step 410.

At step 410, a given duration of time passes. While 5-10 minutes is used as an example time, one of ordinary skill in the art would recognize that such a time period could be configured for either a shorter duration or a longer duration. The method 400 then proceeds to step 412.

At step 412, the method 400 determines whether or not the time limit selected at step 404 has been met. If the time limit has been met, the method 400 proceeds to step 432. If the time limit has not been met, the method 400 proceeds to step 414.

If the time limit has been met, the method 400 proceeds to step 432 at which the system proceeds to save open documents and shut itself down. The method 400 then proceeds to end at step 434.

If the time limit has not been met, the method 400 proceeds to step 414 from step 412. At step 414, the power management module checks the system for new processes and the battery charge level. If less than 1% of the battery power has been consumed, the method proceeds to step 430. Otherwise the method 400 proceeds to step 418.

At step 430, reached from step 414 when less than 1% of the battery life has been consumed and no new processes have been added, the method 400 adjusts the system power profile to meet the deadline in accordance with the lack of overall battery usage. Since the battery has not experienced noticeable drain, the method will respond by changing to a higher performance power profile, if possible. The method then proceeds to step 432.

If more than 1% battery life has been consumed and/or new processes have begun execution, the method 400 proceeds from step 414 to step 418. At step 418, the method 400 calculates the current power resources and current power consumption to determine if the selected duration can still be reached. If the time limit cannot be reached, even with the lowest performance power profile, the method proceeds to step 424. If the power profile can be maintained or adjusted to meet the selected duration, the method proceeds to step 420.

At step 424, reached from step 418 when the duration cannot be reached, the method 400 offers alternatives and options for the user to continue operation of the computing device, such as displaying a message to recharge the device or swap the battery. Possible alternatives offered by the method include displaying a message asking the user to recharge the device or swap the battery, a message to allow the user to safely save documents and shut down the computer system, or an option to ignore the messages and allow the user to continue operating the computer system until the battery fails.

If the User chooses to ignore these warnings the system will take control when the battery reaches a critical level. The user's open documents and temp files will be saved to the HDD and the system will tell them this has occurred and that a shutdown will occur in one minute. This allows the user time to swap power source or shutdown themselves. The method 400 then ends at step 434.

At step 420, reached from step 418 if the duration can still be reached, the method 400 determines whether the system needs to enter a lower performance power profile to meet the duration. This may include auto saving open documents and closing the associated applications, exiting background processes and applications that have not been recently accessed, and the like. If the current power profile is sufficient to meet the deadline, then the method 400 may not make any changes to the system. The method 400 then proceeds to step 422.

At step 422, the method 400 proceeds back to step 410, where the duration continues to be checked periodically to maintain the power level until the selected duration is complete. This eventually leads to the end of the method 400 via either step 432 or step 424.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A method for providing power management for a battery operated computing device, the method comprising:
receiving an indication that the computing device is in a non-user-interactable state; and
powering down non-essential device components such that the computing device is configured to enter a low power state, from which the computing device can recover to full network activity without needing to restart an operating system of the computing device after that the computing device has exited the non-user-interactable state.

2. The method of claim 1, wherein the indication is a lid closed notification.

3. The method of claim 2, wherein the lid closed notification is received via a sensor in a lid latch.

4. The method of claim 1, further comprising powering up the non-essential device components in response to the computing device returning to a user-interactable state.

5. The method of claim 4, wherein the computing device returns to full network activity within two seconds of returning to a user-interactable state.

6. A method for providing power management for a battery operated computing device, the method comprising:
selecting a duration for a battery life of the computing device; and
selecting a power profile for the computing device to ensure that the computing device operates for at least as long as the selected duration.

7. The method of claim 6, further comprising:
monitoring a battery level of the computing device; and
determining whether the power profile of the computing device will continue to operate for at least as long as the selected duration in response to the monitored battery level.

8. The method of claim 7, further comprising:
monitoring a battery consumption rate level of the computing device; and
determining whether the power profile of the computing device continue to operate for at least as long as the selected duration in response to the monitored consumption rate and the monitored battery level.

9. The method of claim 8, further comprising altering the power profile of the computing device to ensure that the computing device will continue to operate for at least as long as the selected duration in response to the monitored consumption rate and the monitored battery level.

10. The method of claim 7, further comprising determining the battery level every 5 minutes.

11. The method of claim 8, further comprising monitoring a process list to determine when new processes are executed.

12. The method of claim 11, further comprising altering the power profile of the computing device to a lower performance power profile when new processes are detected.

13. The method of claim 9, further comprising altering the power profile of the computing device to a higher performance power profile when the higher performance power profile is capable of sustaining the computing device for at least as long as the selected duration.

14. The method of claim 9, further comprising altering the power profile of the computing device to a lower performance power profile when a current power profile of the computing device is insufficient to ensure operation of the computing device for the selected duration and the lower performance power profile is sufficient to ensure operation of the computing device for the selected duration.

15. The method of claim 6, further comprising saving and closing all open documents and shutting down the computing device when the selected duration is reached.

16. A computing device for providing battery power management functionality, the computing device comprising:
means for providing battery power;
means for altering a power profile of the computing device.

17. The computing device of claim 16, further comprising:
means for receiving an indication that the computing device is in a non-user-interactable state; and wherein the means for altering the power profile of the computing device enters a low performance power profile upon entering the non-user-interactable state.

18. The computing device of claim 17, wherein the computing device is a laptop computer and wherein the non-user-interactable state indicates that the lid of the laptop computer is closed.

19. The computing device of claim 16, further comprising:
means for selecting a duration for a device battery to last;
means for monitoring a current power level of the device battery;
means for monitoring a rate of consumption of the device battery;
means for determining whether the rate of consumption and the current power level will allow the computing device to continue operating for the selected duration; and
means for altering the power profile of the computing device in response to the determination as to whether the battery will last for the selected duration.
